(19) United States
(12) Patent Application Publication
(10) Pub. No.: US 2025/0219480 A1
(43) Pub. Date: Jul. 3, 2025

(54) ELECTRIC MOTOR AND AIR CONDITIONER

(71) Applicant: Mitsubishi Electric Corporation, Tokyo (JP)

(72) Inventors: Ryogo TAKAHASHI, Tokyo (JP); Kazuchika TSUCHIDA, Tokyo (JP); Takanori WATANABE, Tokyo (JP); Takaya SHIMOKAWA, Tokyo (JP)

(21) Appl. No.: 18/716,226

(22) PCT Filed: Feb. 7, 2022
(86) PCT No.: PCT/JP2022/004588

§ 371 Date: Jun. 4, 2024

(51) Int. Cl. H02K 1/18; H02K 3/32; H02K 9/22

(52) U.S. Cl. CPC H02K 1/185; H02K 3/32; H02K 9/22

(57) ABSTRACT

An electric motor includes a rotor, a stator, a bracket, and a screw. The stator includes a stator core, a resin component having a fixing hole, and a molded resin molded unitedly with the stator core and the resin component. The molded resin is a thermosetting resin, The resin component is a thermoplastic resin. The resin component includes an opening and a bottom. An inside diameter of the fixing hole decreases from the opening to the bottom.

### CROSS-REFERENCE TO RELATED APPLICATION

This application is a U.S. national stage application of PCT/JP2022/004588 filed Feb. 7, 2022, the contents of which are incorporated herein by reference.

### TECHNICAL FIELD

The present disclosure relates to an electric motor and an air conditioner.

### BACKGROUND

Generally, a molded resin that is molded together with a stator core is used in an electric motor (see, for example, Patent Reference 1).

### PATENT REFERENCE

Patent Reference 1: Japanese Unexamined Patent Application Publication No. H01-039244

When s screw hole is formed directly in a molded resin that is molded unitedly with the stator core, appropriate machining accuracy may not be achieved depending on a material for the molded resin, and the screw may not be sufficiently fixed to the molded resin. As a result, there is a problem in that a component such as a bracket cannot be sufficiently fixed to the stator by the screw.

### SUMMARY

It is an object of the present disclosure to provide an electric motor or air conditioner in which a component such as a bracket can be sufficiently fixed to a stator by a screw.

An electric motor according to the present disclosure includes:
a stator including a stator core, at least one resin component having at least one fixing hole, a molded resin molded unitedly with the stator core and the at least one resin component;
a rotor disposed inside the stator;
a bracket covering an inside of the stator; and
at least one screw fitted into the fixing hole and fixing the bracket to the stator, wherein
the molded resin is a thermosetting resin,
the resin component is a thermoplastic resin,
the resin component includes an opening and a bottom,
an inside diameter of the bottom is smaller than an inside diameter of the opening, and
   an inside diameter of the fixing hole decreases from the opening to the bottom.

An air conditioner according to the present disclosure includes:
an indoor unit; and
an outdoor unit to be connected to the indoor unit, wherein
the indoor unit, the outdoor unit, or each of the indoor unit and the outdoor unit includes the electric motor.

According to the present disclosure, it is possible to provide the electric motor or air conditioner in which a component such as the bracket can be sufficiently fixed to the stator by the screw.

### BRIEF DESCRIPTION OF THE DRAWINGS

FIG. 1 is a cross-sectional view schematically showing an electric motor according to a first embodiment.

FIG. 2 is a diagram schematically showing an example of a rotor core.

FIG. 3 is a diagram schematically showing another example of the rotor core.

FIG. 4 is a cross-sectional view schematically showing a structure of a resin component.

FIG. 5 is a diagram showing the location of a plurality of resin components.

FIG. 6 is a diagram showing the location of the plurality of resin components.

FIG. 7 is a diagram showing a connecting member that connects two or more resin components.

FIG. 8 is a diagram showing the connecting member that connects the two or more resin components.

FIG. 9 is an exploded view of the electric motor shown in FIG. 1.

FIG. 10 is a cross-sectional view schematically showing another example of the electric motor.

FIG. 11 is a cross-sectional view schematically showing yet another example of the electric motor.

FIG. 12 is a cross-sectional view schematically showing yet another example of the electric motor.

FIG. 13 is a cross-sectional view schematically showing yet another example of the electric motor.

FIG. 14 is a diagram schematically showing a configuration of an air conditioner according to a second embodiment.

### DETAILED DESCRIPTION

### First Embodiment

An electric motor 1 according to a first embodiment will be described below.

In an xyz orthogonal coordinate system shown in each drawing, a z-axis direction (z-axis) represents a direction parallel to the axis A1 of the electric motor 1, an x-axis direction (x-axis) represents a direction orthogonal to the z-axis direction, and a y-axis direction (y-axis) represents a direction orthogonal to both the z-axis direction and the x-axis direction. The axis A1 refers to the rotation center of a rotor 2, that is, the rotation axis of the rotor 2. The direction parallel to the axis A1 is also referred to as the “axial direction of the rotor 2” or simply the “axial direction”. A radial direction refers to a direction along a radius of the rotor 2, a stator 3, or a stator core 31, and refers to a direction orthogonal to the axis A1. An xy plane refers to a plane orthogonal to the axial direction. A circumferential direction of the rotor 2, the stator 3, or the stator core 31 is also referred to simply as the “circumferential direction”.

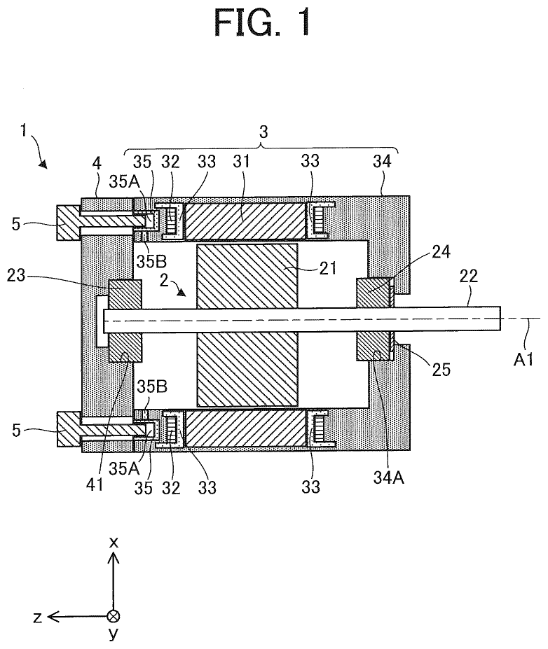

FIG. 1 is a cross-sectional view schematically showing the electric motor 1 according to the first embodiment.

The electric motor 1 includes the rotor 2, the stator 3, a bracket 4, and at least one screw 5. The electric motor 1 is, for example, not limited to, a permanent magnet synchronous motor.

### Rotor 2

The rotor 2 is disposed rotatably inside the stator 3. An air gap exists between the rotor 2 and the stator 3. The rotor 2 includes a rotor core 21 (also referred to as a “rotor yoke”), a shaft 22, a first bearing 23, a second bearing 24, and a preloading member 25. The rotor 2 is rotatable about the rotation axis (i.e., axis A1). The rotor 2 may further include a permanent magnet to form a magnetic pole of the rotor 2. The rotor core 21 is provided between the first bearing 23 and the second bearing 24.

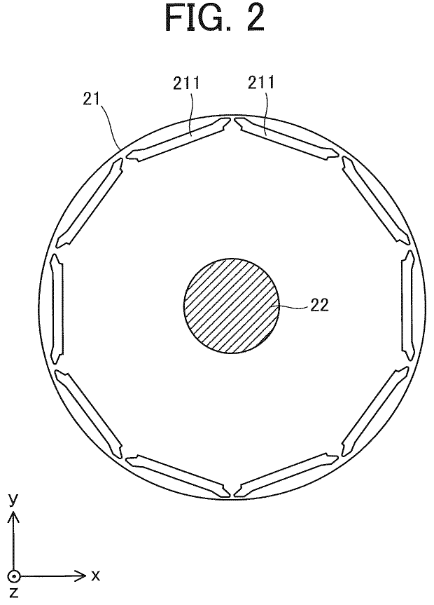

FIG. 2 is a diagram schematically showing an example of the rotor core 21.

The rotor core 21 includes a plurality of magnet insertion holes 211, These magnet insertion holes 211 are arranged in a circumferential direction. At least one permanent magnet is disposed in each magnet insertion hole 211.

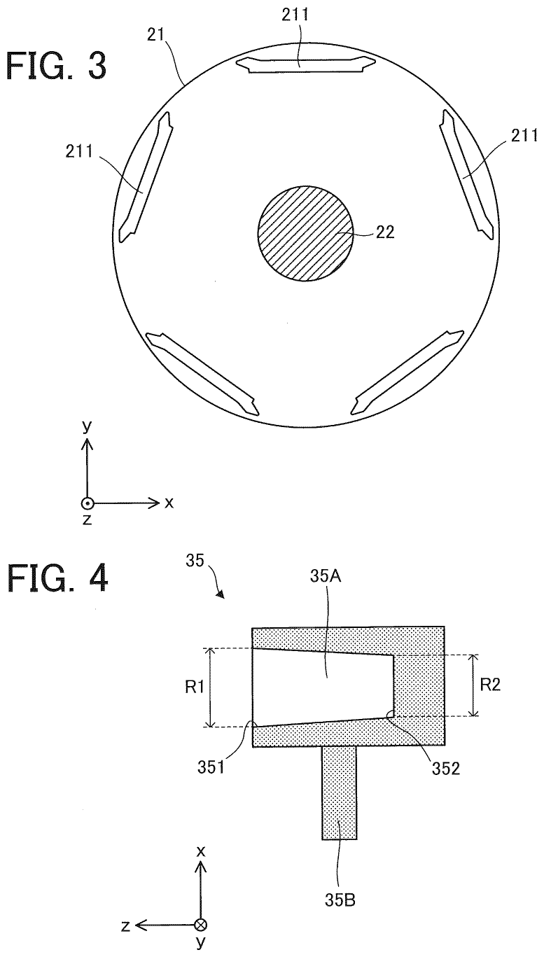

FIG. 3 is a diagram schematically showing another example of the rotor core 21. In the example shown in FIG. 3, the rotor core 21 is a consequent pole type. That is, the rotor core 21 shown in FIG. 3 is used in a consequent pole rotor. At least one permanent magnet is disposed in each magnet insertion hole 211. In this case, the rotor 2 is a consequent pole rotor.

The shaft 22 is provided inside the rotor core 21. The shaft 22 is rotatably supported by the first bearing 23 and the second bearing 24.

The first bearing 23 and the second bearing 24 rotatably support the shaft 22 of the rotor 2. In the example shown in FIG. 1, the first bearing 23 is located on an anti-load side of the electric motor 1 from the rotor core 21. The first bearing 23 rotatably supports the anti-load side of the shaft 22. In the example shown in FIG. 1, the second bearing 24 is located on a load side of the electric motor 1 from the rotor core 21. The second bearing 24 rotatably supports the load side of the shaft 22.

The first bearing 23 and the second bearing 24 are, for example, rolling bearings. When the first bearing 23 and the second bearing 24 are rolling bearings, vibration of the rotor 2 due to magnetic attractive force between the rotor 2 and the stator 3 can be prevented compared to plain bearings.

The preloading member 25 provides preload to the second bearing 24. The preloading member 25 is, for example, a compression spring.

### Stator 3

As shown in FIG. 1, the stator 3 includes the stator core 31, at least one winding 32 (also referred to as a stator winding), at least one insulating member 33, a molded resin 34, and at least one resin component 35.

The stator core 31 is a cylindrical core. For example, the stator core 31 is formed of a plurality of electrical steel sheets laminated in the axial direction. In this case, each of the electrical steel sheets is formed into a predetermined shape with blanking. These electrical steel sheets are fixed to each other by caulking, welding, gluing, or the like.

The winding 32 is, for example, a magnet wire. The winding 32 is wound on the insulating member 33. The winding 32 is wound on the insulating member 33, thereby forming a coil.

The insulating member 33 is, for example, a thermoplastic resin such as polybutylene terephthalate (PBT). The insulating member 33 electrically insulates the stator core 31. For example, the insulating member 33 is molded unitedly with the stator core 31. However, the insulating member 33 may be molded in advance, and then the molded insulating member 33 may be combined with the stator core 31.

The molded resin 34 is molded unitedly with the stator core 31 and at least one resin component 35. The molded resin 34 is molded by a mold, for example. The molded resin 34 covers at least part of the stator core 31. For example, the molded resin 34 covers an outer peripheral surface of the stator core 31. The molded resin 34 is, for example, a thermosetting resin such as a bulk molding compound (BMC).

In the example shown in FIG. 1, the molded resin 34 includes a bearing housing 34A. The bearing housing 34A holds the second bearing 24.

Each resin component 35 is embedded in the molded resin 34 together with the winding 32 and the insulating member 33. Each resin component 35 may be combined with the stator core 31. Each resin component 35 has at least one fixing hole 35A. Each resin component 35 may have two or more fixing holes 35A. Each fixing hole 35A is exposed outside the stator 3. In the example shown in FIG. 1, each fixing hole 35A extends in the axial direction. That is, each fixing hole 35A is provided at an end of the stator 3 in the axial direction. However, each fixing hole 35A may be provided at an end of the stator 3 in the radial direction.

Each resin component 35 is a thermoplastic resin such as polybutylene terephthalate (PBT).

FIG. 4 is a cross-sectional view schematically showing the structure of the resin component 35.

As shown in FIG. 4, the resin component 35 includes an opening 351 and a bottom 352. The inside diameter of the fixing hole 35A decreases from the opening 351 to the bottom 352. In the example shown in FIG. 4, the inside diameter R2 of the bottom 352 is smaller than the inside diameter R1 of the opening 351.

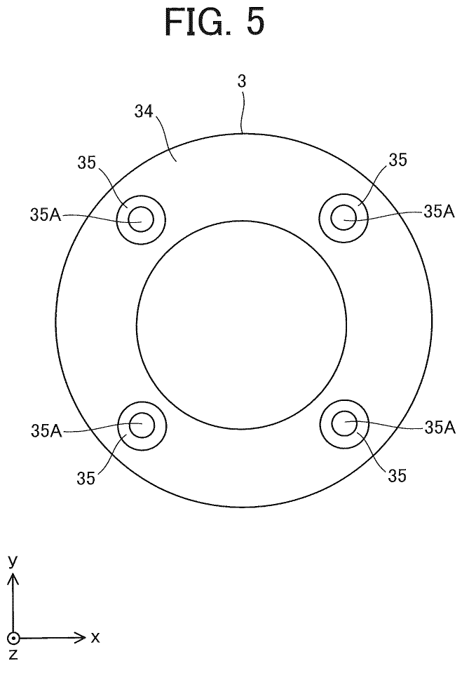

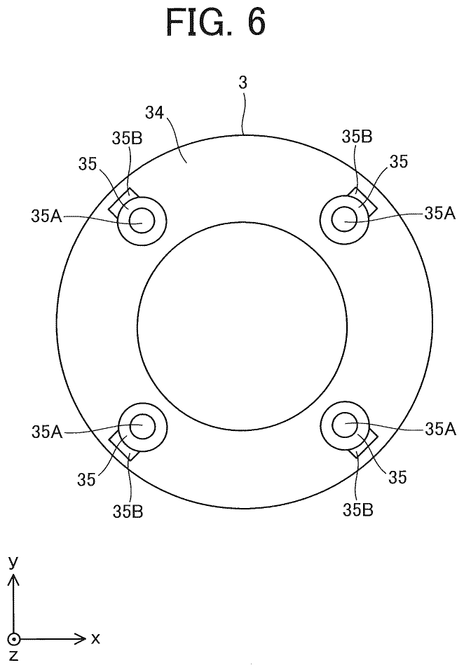

FIG. 5 and FIG. 6 are diagrams showing the location of the plurality of resin components 35.

In the present embodiment, the stator 3 includes two or more resin components 35. The two or more resin components 35 are arranged at equal intervals in the circumferential direction. Each of these two or more resin components 35 has at least one fixing hole 35A. In this case, the two or more fixing holes 35A are arranged at equal intervals in the circumferential direction. In other words, the two or more fixing holes 35A are arranged at equal intervals in the circumferential direction about the rotation axis of the rotor 2.

As shown in FIG. 6, the resin component 35 may include a protrusion 35B extending in the radial direction from the outer peripheral surface of the resin component 35. The protrusion 35B may extend inward in the radial direction or outward in the radial direction. In the example shown in FIG. 1, each protrusion 35B extends inward in the radial direction from the outer peripheral surface of the resin component 35. In the example shown in FIG. 6, each protrusion 35B extends outward in the radial direction from the outer peripheral surface of the resin component 35.

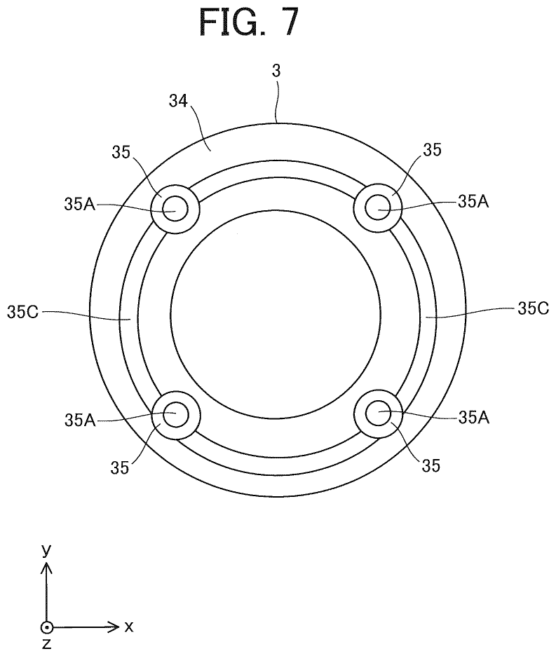

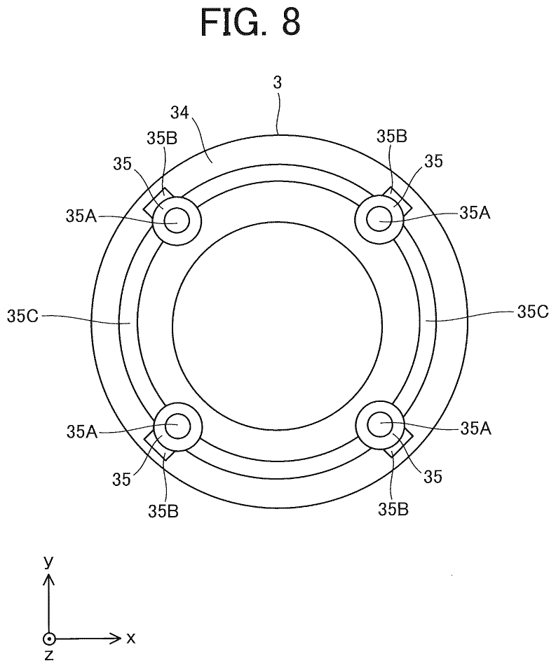

FIG. 7 and FIG. 8 are diagrams showing a connecting member 35C that connects two or more resin components 35.

As shown in FIG. 7 and FIG. 8, the stator 3 may include at least one connecting member 35C that connects two or more resin components 35.

### Bracket 4

A bracket 4 covers the inside of the stator 3. The bracket 4 is made of resin or metal. The bracket 4 includes a bearing housing 41. The bearing housing 41 holds the first bearing 23.

### Screw 5

In the example shown in FIG. 1, the electric motor 1 includes two screws 5. Each screw 5 is fitted into the fixing hole 35A and fixes the bracket 4 to the stator 3.

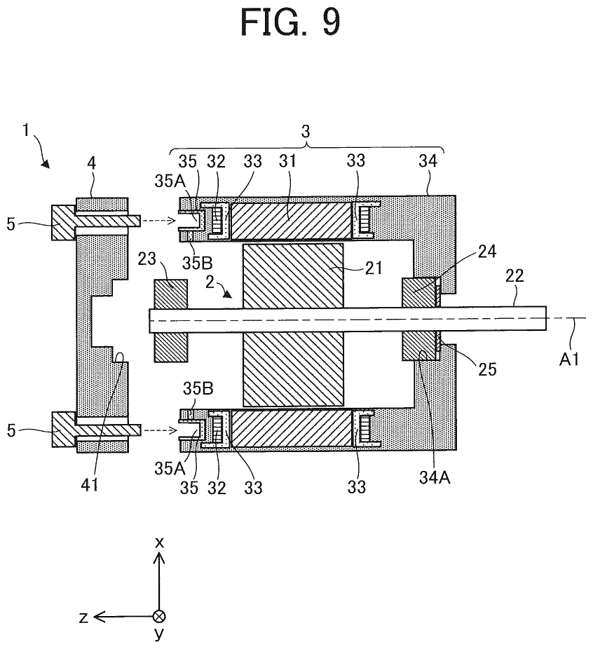

FIG. 9 is an exploded view of the electric motor 1 shown in FIG. 1.

As shown in FIG. 9, each screw 5 is fitted into the fixing hole 35A. With this configuration, the bracket 4 is fixed to the stator 3 by the screws 5.

### Modifications

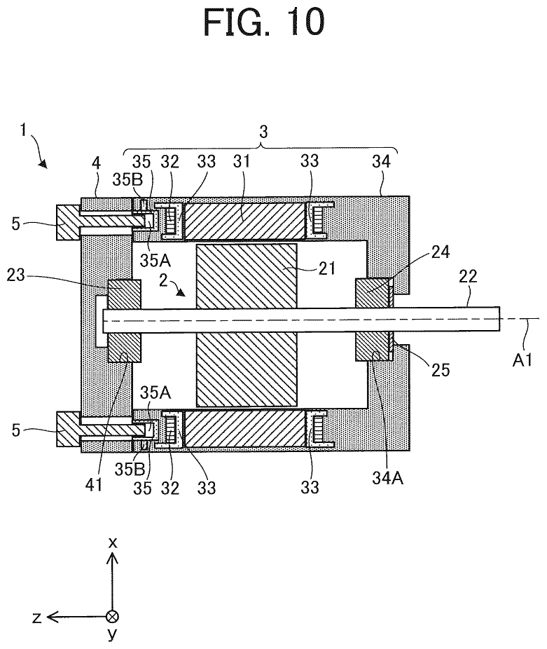

FIG. 10 is a cross-sectional view schematically showing another example of the electric motor 1.

In the example shown in FIG. 10, each protrusion 35B extends outward in the radial direction from the outer peripheral surface of the resin component 35.

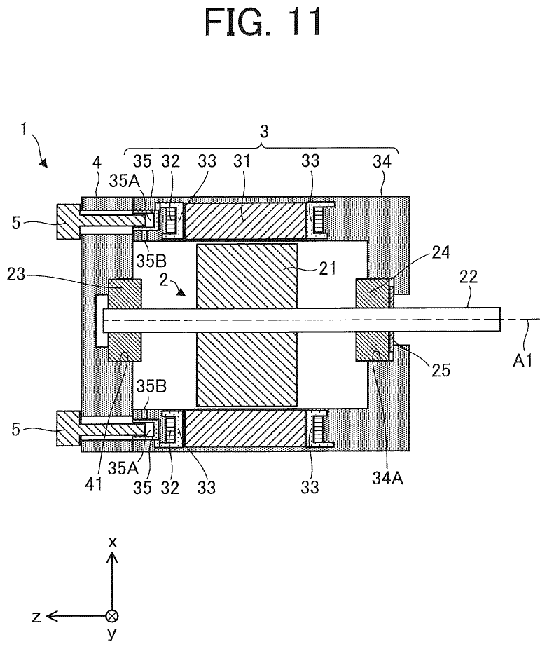

FIG. 11 is a cross-sectional view schematically showing yet another example of the electric motor 1.

In the example shown in FIG. 11, each resin component 35 is combined with the insulating member 33. With this configuration, each resin component 35 is fixed to the insulating member 33. Each insulating member 33 may include a fixing portion to fix the resin component 35. For example, the fixing portion of the insulating member 33 is engaged with the resin component 35.

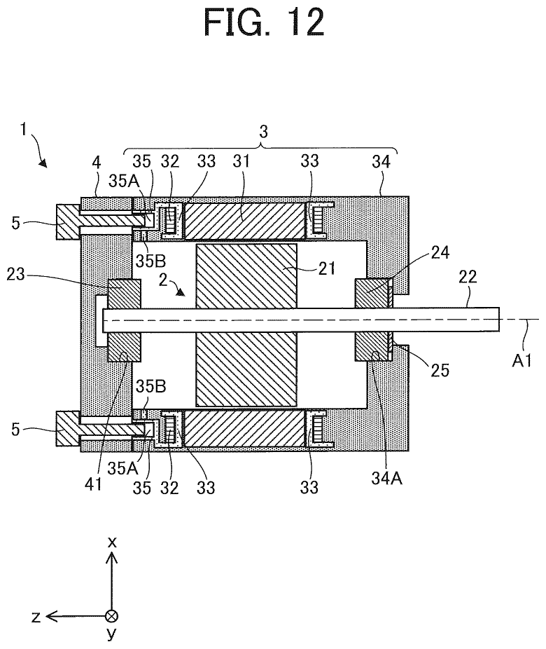

FIG. 12 is a cross-sectional view schematically showing yet another example of the electric motor 1.

In the example shown in FIG. 12, each resin component 35 is integrated with the insulating member 33 as a single component.

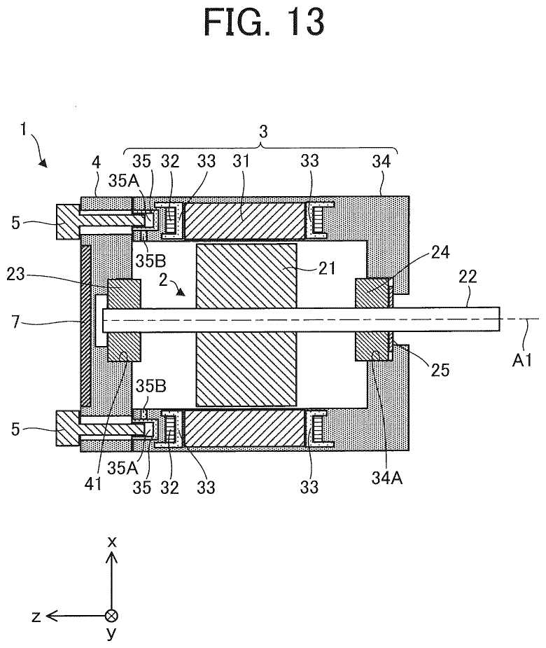

FIG. 13 is a cross-sectional view schematically showing yet another example of the electric motor 1.

In the example shown in FIG. 13, the electric motor 1 includes a metal component 7. The bracket 4 covers part of the metal component 7. That is, other parts of the metal component 7 are exposed outside the electric motor 1. This configuration allows the metal component 7 to radiate heat from the electric motor 1 to the outside of the electric motor 1. The metal component 7 is, for example, aluminum.

### Advantages of Present Embodiment

Generally, when a screw hole is formed directly in a molded resin that is molded unitedly with a stator core, appropriate machining accuracy may not be achieved depending on a material for the molded resin, and the screw may not be sufficiently fixed to the molded resin. As a result, there is a problem in that a component such as a bracket cannot be sufficiently fixed to the stator by the screw.

According to the present embodiment, since the stator 3 includes the molded resin 34 molded unitedly with the stator core 31 and the resin component 35, deterioration of the molded resin 34 can be prevented, and the screw 5 is sufficiently fixed in the fixing hole 35A of the resin component 35 compared to the configuration in which a screw hole is formed directly in the molded resin 34. As a result, the bracket 4 can be sufficiently fixed to the stator 3 by the screw 5.

Normally, since thermoplastic resin does not have good machining accuracy, the vibration and noise in an electric motor during the rotation of its rotor becomes worse if the molded resin is a thermoplastic resin. In contrast to this, in the present embodiment, since the molded resin 34 is a thermosetting resin, the machining accuracy of the molded resin 34 can be enhanced. As a result, the vibration and noise in the electric motor 1 during the rotation of the rotor 2 can be reduced.

Normally, since a thermosetting resin is easily damaged, embedding a screw directly into the thermosetting resin deteriorates a fixing hole, and thus the screw is not be sufficiently fixed in the fixing hole. In contrast to this, in the present embodiment, the resin component 35 forming the fixing hole 35A is a thermoplastic resin, and thus the resin component 35 can sufficiently hold the screw 5 compared to a thermosetting resin.

The inside diameter of the fixing hole 35A decreases from the opening 351 to the bottom 352. Therefore, the screw 5 can be sufficiently held. In the manufacturing process of the electric motor 1, a mold forming the fixing hole 35A can be easily removed from the molded resin 34.

When the resin component 35 has two or more fixing holes 35A, force required to fix the bracket 4 can be distributed. As a result, the size of each screw 5 can be made small.

When the resin component 35 includes a protrusion 35B extending in the radial direction from the outer peripheral surface of the resin component 35, the misalignment of the resin component 35 can be prevented. In fixing the screw 5 to the fixing hole 35A in the manufacturing process of the electric motor 1, the misalignment of the resin component 35 can be effectively prevented.

It is preferable that each of the protrusions 35B should be covered with the molded resin 34. This configuration can effectively prevent the misalignment of the resin component 35.

When the resin component 35 is combined with the stator core 31, the misalignment of the resin component 35 can be prevented. In the manufacturing process of the electric motor 1, the resin component 35 and the stator core 31 can be handled together before molding the molded resin 34, thereby making it easier to manufacture the electric motor 1.

When the resin component 35 is combined with the insulating member 33, the misalignment of the resin component 35 can be prevented. In the manufacturing process of the electric motor 1, the resin component 35 can be easily fixed to the insulating member 33, and the resin component 35 can be easily positioned. In addition, the resin component 35 can be prevented from falling off the stator 3.

When the stator 3 includes a plurality of resin components 35, the force required to fix the bracket 4 can be distributed.

When the plurality of fixing holes 35A are arranged at equal intervals in the circumferential direction, the bracket 4 can be fixed to the stator 3 with equal strength in the circumferential direction. As a result, the vibration in the electric motor 1 during the rotation of the rotor 2 can be reduced.

It is preferable that the plurality of fixing holes 35A should be arranged concentrically about the rotation axis of the rotor 2 and equally spaced in the circumferential direction. This configuration allows the bracket 4 to be fixed to the stator 3 with more even strength in the circumferential direction. As a result, the vibration in the electric motor 1 during the rotation of the rotor 2 can be further reduced.

When the stator 3 includes the connecting member 35C, the number of components for the plurality of fixing holes 35A can be reduced. In the manufacturing process of the electric motor 1, the plurality of fixing holes 35A can be easily provided in the stator 3.

When the resin component 35 is integrated with the insulating member 33 as a single component, the number of components for the plurality of fixing holes 35A can be reduced, In the manufacturing process of the electric motor 1, the process of fixing the resin component 35 can be reduced.

When the bracket 4 is made of resin, corrosion at the parts in contact with the screw 5 can be prevented. In addition, since the bearing housing 41 is a resin, electrolytic corrosion in the first bearing 23 can be prevented. As a result, the vibration and noise in the electric motor 1 during the rotation of the rotor 2 can be prevented.

When the bracket 4 is made of metal, the heat of the electric motor 1 can be radiated to the outside of the electric motor 1. In addition, the rigidity of the electric motor 1 can be enhanced.

When the electric motor 1 includes the metal component 7, the metal component 7 can radiate the heat of the electric motor 1 to the outside of the electric motor 1. In particular, when part of the metal component 7 is exposed outside the electric motor 1, the metal component 7 can effectively radiate the heat of the electric motor 1 to the outside of the electric motor 1. Furthermore, in this case, when the bearing housing 41 is a resin, the electric corrosion in the first bearing 23 can be prevented. As a result, both the heat radiation and the prevention of the electric corrosion can be achieved.

When the metal component 7 is aluminum, heat radiation efficiency can be increased. As a result, the heat of the electric motor 1 can be effectively radiated to the outside of the electric motor 1.

In general, when a rotor is a consequent pole rotor, the excitation force due to magnetic unbalance is large. According to the present embodiment, the bracket 4 is fixed to the stator 3 by the screw 5, and thus the bracket 4 is prevented from falling off due to the vibration in the electric motor 1 even if the rotor 2 is a consequent pole rotor.

### Second Embodiment

An air conditioner 10 (also referred to as a refrigerating and air conditioning apparatus or a refrigeration cycle apparatus) according to a second embodiment will be described.

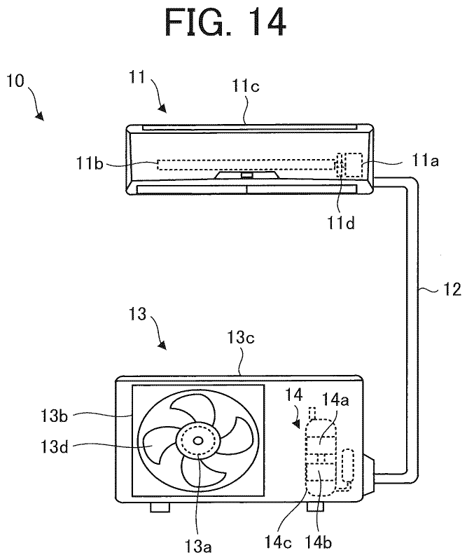

FIG. 14 is a diagram schematically showing the configuration of the air conditioner 10 according to the second embodiment.

The air conditioner 10 according to the second embodiment includes an indoor unit 11 as a blower (also referred to as a first blower) and an outdoor unit 13 as a blower (also referred to as a second blower) to be connected to the indoor unit 11.

In the present embodiment, the air conditioner 10 includes the indoor unit 11, refrigerant piping 12, and the outdoor unit 13. For example, the outdoor unit 13 is connected to the indoor unit 11 through the refrigerant piping 12.

The indoor unit 11 includes an electric motor 11a (e.g., the electric motor 1 according to the first embodiment), a blowing unit 11b that sends air by being driven by the electric motor 11a, and a housing 11c that covers the electric motor 11a and the blowing unit 11b. The blowing unit 11b includes, for example, a blade 11d to be driven by the electric motor 11a. For example, the blade 11d is fixed to the shaft of the electric motor 11a and generates airflow.

The outdoor unit 13 includes an electric motor 13a (e.g., the electric motor 1 according to the first embodiment), a blowing unit 13b, a compressor 14, a heat exchanger (not shown), and a housing 13c that covers the blowing unit 13b, the compressor 14, and the heat exchanger. The blowing unit 13b is driven by the electric motor 13a and sends air. The blowing unit 13b includes, for example, a blade 13d to be driven by the electric motor 13a. For example, the blade 13d is fixed to the shaft of the electric motor 13a and generates airflow. The compressor 14 includes an electric motor 14a (e.g., the electric motor 1 according to the first embodiment), a compression mechanism 14b (e.g., a refrigerant circuit) to be driven by the electric motor 14a, and a housing 14c that covers the electric motor 14a and the compression mechanism 14b.

In the air conditioner 10, at least one of the indoor unit 11 or the outdoor unit 13 includes the electric motor 1 described in the first embodiment. That is, the indoor unit 11, the outdoor unit 13, or each of the indoor unit 11 and the outdoor unit 13 includes the electric motor 1 described in the first embodiment. Specifically, the electric motor 1 described in the first embodiment is applied to at least one of the electric motors 11a or 13a as a driving source of the blowing unit. In other words, the electric motor 1 described in the first embodiment is applied to the indoor unit 11, the outdoor unit 13, or each of the indoor unit 11 and the outdoor unit 13. The electric motor 1 described in the first embodiment may be applied to the electric motor 14a of the compressor 14.

The air conditioner 10 can perform air conditioning, for example, cooling operation in which cold air is blown from the indoor unit 11 or heating operation in which warm air is blown from the indoor unit 11. In the indoor unit 11, the electric motor 11a is a driving source for driving the blowing unit 11b. The blowing unit 11b can send conditioned air.

In the indoor unit 11, the electric motor 11a is fixed to the housing 11c of the indoor unit 11, for example, by a screw. In the outdoor unit 13, the electric motor 13a is fixed to the housing 13c of the outdoor unit 13, for example, by a screw.

In the air conditioner 10 according to the second embodiment, since the electric motor 1 described in the first embodiment is applied to at least one of the electric motors 11a or 13a, the same advantages as those described in the first embodiment can be obtained. As a result, vibration and noise in the air conditioner 10 can be reduced.

In addition, when the electric motor 1 according to the first embodiment is used as the driving source of a blower (e.g., indoor unit 11), the same advantages described in the first embodiment can be obtained. As a result, vibration and noise in the blower can be reduced. The blower including the electric motor 1 according to the first embodiment and the blade (e.g., blade 11d or 13d) to be driven by the electric motor 1 can be used alone as a device to send air. The blower can also be applied to devices other than the air conditioner 10.

In addition, when the electric motor 1 according to the first embodiment is used as the driving source of the compressor 14, the same advantages described in the first embodiment can be obtained. As a result, vibration and noise in the compressor 14 can be reduced.

In addition to the air conditioner 10, the electric motor 1 described in the first embodiment can be mounted on equipment that includes a driving source, such as ventilators, home appliances, or machine tools.

The features in each of the embodiments and modifications described above can be combined with each other.

1. An electric motor comprising:
a stator including a stator core, at least one resin component having at least one fixing hole, a molded resin molded unitedly with the stator core and the at least one resin component;
a rotor disposed inside the stator;
a bracket covering an inside of the stator; and
at least one screw fitted into the fixing hole and fixing the bracket to the stator, wherein
the molded resin is a thermosetting resin,
the resin component is a thermoplastic resin,
the resin component includes an opening and a bottom,
an inside diameter of the bottom is smaller than an inside diameter of the opening, and
an inside diameter of the fixing hole decreases from the opening to the bottom.

2. The electric motor according to claim 1, wherein the at least one fixing hole comprises two or more fixing holes.

3. The electric motor according to claim 2, wherein the two or more fixing holes are arranged at equal intervals in a circumferential direction of the stator.

4. The electric motor according to claim 2, wherein the resin component has the two or more fixing holes.

5. The electric motor according to claim 1, wherein the resin component includes a protrusion extending in a radial direction of the stator from an outer peripheral surface of the resin component.

6. The electric motor according to claim 1, wherein the resin component is combined with the stator core.

7. The electric motor according to claim 1, wherein
the stator includes an insulating member insulating the stator core, and
the resin component is combined with the insulating member.

8. The electric motor according to claim 1, wherein
the at least one resin component comprises two or more resin components, and
each of the two or more resin components has the at least one fixing hole.

9. The electric motor according to claim 8, wherein the two or more resin components are arranged at equal intervals in a circumferential direction of the stator.

10. The electric motor according to claim 8, wherein the stator includes a connecting member connecting the two or more resin components.

11. The electric motor according to claim 1, wherein
the stator includes an insulating member insulating the stator core, and
the resin component is integrated with the insulating member as a single component.

12. The electric motor according to claim 1, wherein the bracket is made of resin.

13. The electric motor according to claim 12, further comprising a metal component to radiate heat of the electric motor to an outside of the electric motor, wherein
the resin covers part of the metal component.

14. The electric motor according to claim 13, wherein the metal component is aluminum.

15. The electric motor according to claim 1, wherein the bracket is made of metal.

16. The electric motor according to claim 1, wherein the rotor is a consequent pole rotor.

17. An air conditioner comprising:
an indoor unit; and
an outdoor unit to be connected to the indoor unit, wherein
the indoor unit, the outdoor unit, or each of the indoor unit and the outdoor unit includes the electric motor according to claim 1.

18. The electric motor according to claim 9, wherein the stator includes a connecting member connecting the two or more resin components.

19. The electric motor according to claim 2, wherein
the stator includes an insulating member insulating the stator core, and
the resin component is integrated with the insulating member as a single component.
